(19) United States
(12) Patent Application Publication
(10) Pub. No.: US 2009/0068940 A1
(43) Pub. Date: Mar. 12, 2009

(54) Closing screen for a ventilation opening, in particular for a ventilation opening of a motor vehicle

(76) Inventors: Heinz Bloemeling, Leichlingen (DE); Detlev Werheid, Cologne (DE)

Correspondence Address: COLLARD & ROE, P.C., 1077 NORTHERN BOULEVARD, ROSLYN, NY, 11576, US

(21) Appl. No.: 12/231,870

(22) Filed: Sep. 5, 2008

(30) Foreign Application Priority Data
Sep. 7, 2007 (DE) 10 2007 042 621.8

(51) Int. Cl. B60H 1/24

(52) U.S. Cl. 454/162

(57) ABSTRACT

The invention relates to a closing screen for a ventilation opening, in particular for a ventilation opening for a motor vehicle, comprising at least one molded part (1) for fastening to the ventilation opening and at least one ventilation flap (6, 7), which closes an opening (4) embodied in the molded part (1) and which automatically allows for an air escape from the space via the opening (4) in response to an overpressure in an assigned space. To eliminate the appearance of annoying rattling noises during operation in such a closing screen and to enable a cost-efficient production of the closing screen, the molded part (1) and the at least one ventilation flap (6, 7) according to the invention are made of flexible, closed-cell foam, wherein the at least one ventilation flap (6, 7) is connected to the molded part (1) by means of a material connection or integrally.

The invention relates to a closing screen for a ventilation opening, in particular for a ventilation opening of a motor vehicle comprising at least one molded part for fastening to the ventilation opening and at least one ventilation flap which closes an opening formed in the molded part and which automatically allows for an air escape from an assigned space via the opening in response to an overpressure in the space.

Such closing screens are mounted, for example, at ventilation openings in exterior building walls, in particular at the end of an exhaust air duct of an extractor hood provided with a fan or at exhaust air openings and exhaust air ducts, respectively, of bathrooms. Common closing screens encompass several ventilation flaps embodied in a blind-like manner, which are made of metal or hard plastic and which are supported in a frame-like molded part so as to be capable of being pivoted. When the fan is turned off, the ventilation flaps close the ventilation opening so that a penetration of dust and noise via the ventilation opening into the respective building space is prevented. In the closed state, the ventilation flaps furthermore reduce a heat loss from the building space. In contrast, the ventilation flaps are swung open due to the overpressure generated by means of the fan during operating of the fan. Typically, the ventilation flaps swing open and shut as a function of the overpressure generated by the fan. The intermittent closing of the ventilation flaps made of metal of hard plastic typically produces annoying rattling noises.

Furthermore, such closing screens are also used in motor vehicles, in fact at ventilation openings, which serve the purpose of forced ventilation of the passenger cabin, trunk and trunk compartment, respectively. The air supplied via one or several fresh air ducts increases the air pressure in the passenger cabin and trunk compartment, respectively, so that a portion of the air in the passenger compartment escapes as exhaust air via the respective ventilation opening. The ventilation openings are thereby typically arranged so as to be covered, e.g. behind the rear bumper of the motor vehicle. It goes without saying that surrounding noise can typically penetrate into the passenger cabin and that heat can escape outwards from the passenger cabin, respectively, via the ventilation opening. The closing screen fixed to the ventilation opening thus has an acoustic insulation and heat insulation function. With reference thereto, closing screens which encompass a frame-like plastic injection molded article, ventilation flaps, which are embodied in a blind-like manner being made of elastomer and encompassing a circumferential rubber gasket are known in motor vehicles. Even though the embodiment of the ventilation flaps in the shape of flexible elastomer lamella prevents annoying rattling noises in response to the intermittent closing of the ventilation flaps (lamella), the production of these known closing screens, however, is extensive and causes relatively high costs.

Closing screens of the afore-mentioned type are known from DE 10 2005 024 527 A1 and DE 196 29 115 A1, for example. In each case, the known closing screens have a frame, which defines an opening and which is injection molded from hard plastic, and a ventilation flap made of an elastomer material, wherein the ventilation flap is injection molded on the frames.

The present invention is based on the object of providing a closing screen of the afore-mentioned type where annoying rattling noises do not appear and which can be produced in a cost-efficient manner.

This object is solved by means of a closing screen comprising the features of claim 1.

The closing screen according to the invention comprises at least one molded part for fastening to a corresponding ventilation opening and at least one ventilation flap which closes an opening embodied in the molded part and which automatically allows for an air escape from an assigned space via the opening in response to an overpressure in the assigned space. According to the invention, the molded part and the at least one ventilation flap are made of flexible, closed-cell foam, wherein the at least one ventilation flap is connected to the molded part by means of a material connection or preferably integrally.

Due to the fact that the at least one molded part and the at least one ventilation flap are made of the same cost-efficient material, that is, of flexible, closed-cell foam, the closing screen according to the invention can be realized in a more cost-efficient manner than common closing screens of the above-mentioned type. The closed-cell foam thereby ensures an absolutely rattle-free function of the closing screen and, at the same time, adds very good heat insulation characteristics. Particularly favorable production costs result for the closing screen according to the invention when the at least one ventilation flap thereof is embodied with the molded part so as to be integral, that is, in one piece. In this case, the production step for the material connection of molded part and ventilation flap can be avoided.

A further advantage of the closing screen according to the invention lies in its relatively low weight. Flexible, closed-cell foam is considerably lighter than the material of common closing screens, which are configured from a frame-like plastic injection molded article, ventilation flaps made of elastomer and a circumferential rubber gasket, for example. A weight reduction as compared to common multi-part closing screens can be attained, in particular, by means of the preferred one-piece embodiment of the closing screen according to the invention.

According to a further advantageous embodiment of the closing screen according to the invention, provision is made for the molded part thereof to be embodied in a frame-like manner and to encompass a collar provided with an undercut. The undercut thereby serves the purpose of a simple and rapid assembly of the closing screen to a corresponding ventilation opening. The assembly of the closing screen according to the invention then neither requires additional fastening means nor the use of tools.

With reference thereto, a further preferred embodiment of the closing screen according to the invention provides for the collar to encompass at its outer periphery several bulges embodied in the region of the undercut. Preferably, several pairs of such bulges are available, wherein in each case two bulges of a pair are arranged so as to be located opposite one another. The bulges are assigned to the flange and to the edge periphery, respectively, of the ventilation opening, which is embodied, e.g., in the car body sheet or in a corresponding wall. The collar is dimensioned in such a manner that the outer dimensions thereof are slightly smaller than the inner dimensions of the ventilation opening. According to the invention, however, the bulges embodied in the region of the undercut of the collar are embodied in such a manner that the outer dimensions thereof are slightly larger than the inner dimensions of the ventilation opening. In the assembled state of the closing screen, the bulges have the effect, due to the flexibility as well as elasticity of the foam, that the opening formed in the molded part by means of cutting out of the at least one ventilation flap, is slightly reduced. In the assembled state of the closing screen, the edge of the ventilation flap thus overlaps the opening formed in the molded part at least by the measure of one or two bulges, respectively, so that a good seal is also attained when the at least one ventilation flap is embodied so as to be integral with the molded part.

A particularly reliable closing behavior of the at least one ventilation flap can be attained when according to a further preferred embodiment of the closing screen according to the invention, the at least one ventilation flap is connected to the molded part via a film hinge. The film hinge represents a very flexible, very smooth-running hinge, which, due to the force of gravity acting on the ventilation flap, ensures that the ventilation flap closes the opening embodied in the molded part in a substantially tight manner when there is no overpressure or when the overpressure is too small.

According to a further preferred embodiment of the closing screen according to the invention, the molded part encompasses a circumferential outer flange. The outer flange overlaps and encompasses, respectively, the respective ventilation opening, at which the closing screen according to the invention is assembled. When the circumferential outer flange of the molded part according to a further advantageous embodiment is embodied as a hollow bead, the outer flange can be attached in a circumferentially sealing manner to the surface defining the ventilation opening even when the surface of the edge region enclosing the ventilation opening is not flat, but slightly curved, because the molded part and thus the outer flange embodied as a hollow bead are thus made from flexible closed-cell foam so that the outer flange adapts to the contour of the curved surface.

Further preferred and advantageous embodiments of the closing screen according to the invention are specified in the subclaims.

The invention will be explained below in more detail by means of a drawing illustrating several exemplary embodiments. Diagrammatically

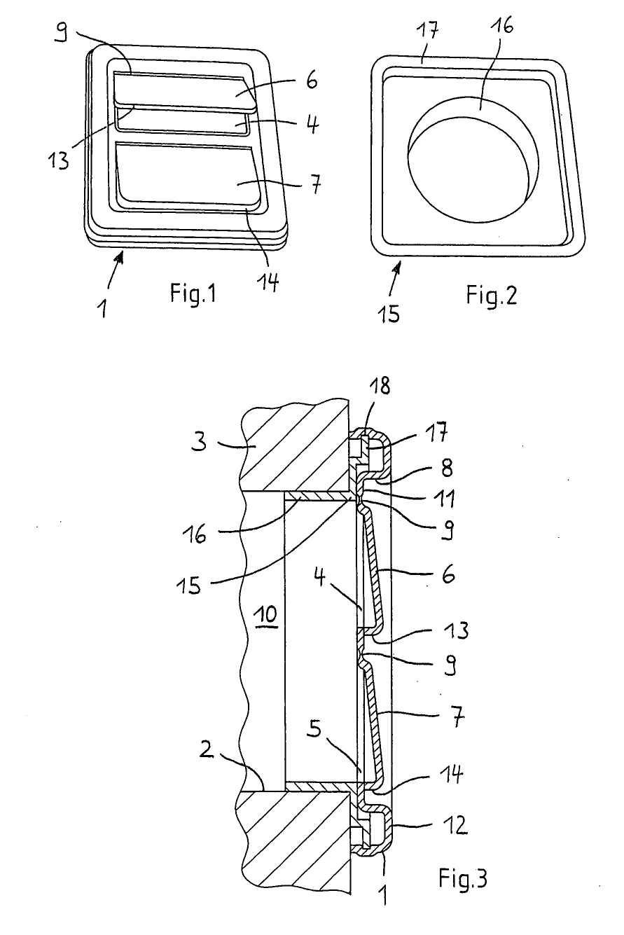

FIG. 1 shows a perspective front view of a molded part according to the invention comprising two ventilation flaps;

FIG. 2 shows a perspective front view of a support according to the invention for detachably fastening the molded part of FIG. 1;

FIG. 3 is a sectional view of a closing screen formed from the molded part of FIG. 1 and the support of FIG. 2 in the assembled state;

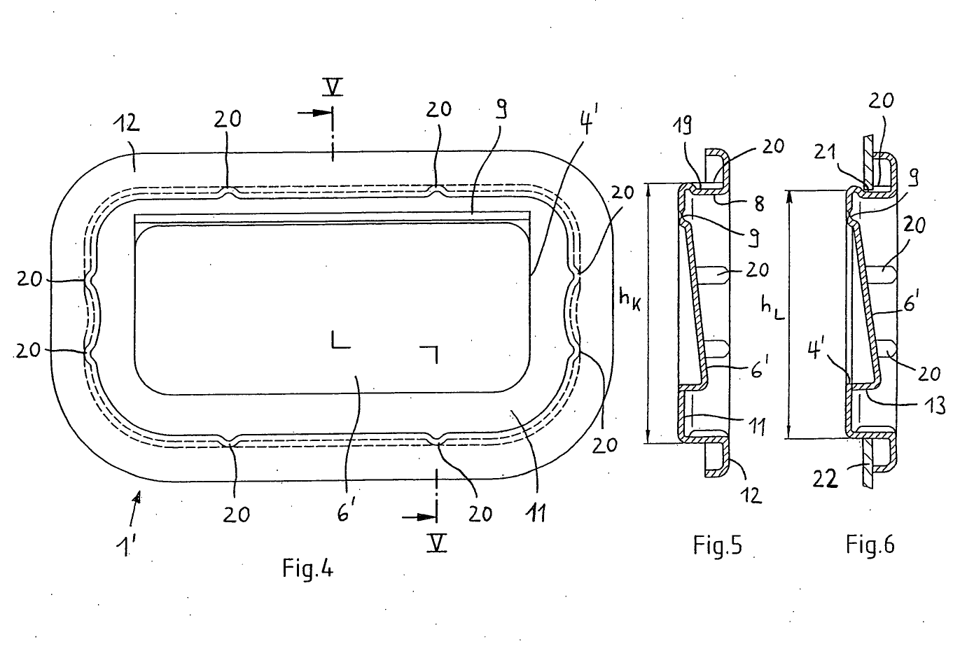

FIG. 4 is a front view of a molded part according to the invention comprising a ventilation flap;

FIG. 5 is a cross sectional view of the molded part of FIG. 4 along the intersection line V-V; and

FIG. 6 is a cross sectional view of the molded part of FIG. 4 along the intersection line V-V in the assembled state.

The closing screen illustrated in FIGS. 1 and 3 substantially consists of a molded part 1 for fastening to a ventilation opening 2, for example to a ventilation opening assigned to an extractor hood in a building wall 3. Openings 4, 5, which each are provided with a ventilation flap 6, 7 are embodied in the molded part 1. The molded part 1 and the ventilation flaps 6, 7 are made of flexible, closed-cell foam. Preferably, the foam is a thermoplastic foam, in particular a polyethylene foam.

The molded part 1 can be made, for example, from a corresponding thermoplastic foam film by means of deep-drawing and die cutting. The thermoplastic foam film is thereby heated prior to and/or during the deep-drawing process and is cooled in the deep-drawing tool.

The molded part 1 is embodied in a frame-like manner and encompasses a collar 8. In the exemplary embodiment illustrated in FIG. 1, the molded part 1 substantially has the shape of a square frame. If required, the molded part 1 can also be embodied differently, for example in a circular, oval, oblong square or triangular manner.

The ventilation flaps 6, 7 are integrally connected to the molded part 1. They are generated by means of cuts in the molded part 1, which are substantially C- or U-shaped. The connecting region between the respective ventilation flap 6, 7 and the molded part 1 is embodied so as to be linear. Preferably, the connecting region is provided with a groove-shaped embossment, which forms a type of film hinge 9. Due to the groove-shaped embossment, the connecting region is highly flexible so that the ventilation flap 6, 7 already swings open automatically in response to a relatively low overpressure in the space 10 assigned to the closing screen and allows for an air escape from the space 10 via the opening 4, 5. When there is no overpressure in the assigned space 10, the respective ventilation flap 6, 7 closes the corresponding opening 4 and 5, respectively. The upper ventilation flap 6 is illustrated in FIG. 1 when swung open.

The molded part 1 has a circumferential ledge 11, which defines the openings 4, 5. Furthermore, the molded part 1 encompasses a circumferential outer flange 12. The outer flange 12 is embodied as a hollow bead. The ledge 11 stands back with respect to the front side and the outer flange 12 of the molded part, respectively. The ventilation flaps 6, 7 are embodied so as to be curved and encompass in each case a collar 13, 14, which serves as a sealing surface. In the closing position, the ventilation flaps 6, 7 do not protrude with respect to the outer flange 12 (see FIG. 3).

Furthermore, the closing screen according to the invention can comprise a support 15, which supports the molded part 1, as a separate additional part. The rear side of the support 15 illustrated in FIGS. 2 and 3 is provided with a pipe connection 16 which is open towards the ventilation flaps 6, 7 to which a ventilation line, for example a flexible, undulated extractor hood line, can be connected. At its front side, the support 15 comprises a stepped, flange-shaped collar 17, to which the molded part 1 can be connected by means of a snap fit. For this purpose, the outer flange 12 of the molded part 1 embodied as a hollow bead is inserted onto the collar 17, which projects at the front side of the support 15. At its inner side, the hollow bead 12 encompasses a circumferential groove 18, which snap-fits with the outer edge of the flange-shaped collar 17. Preferably, the support 15 is made of polypropylene, polystyrene or acrylonitrile-butadiene styrene.

A further exemplary embodiment of a closing screen according to the invention is illustrated in FIGS. 4 to 6. In this example, the molded part 1′ made of flexible, closed-cell foam is provided with only one ventilation flap 6′, which closes an opening 4′ embodied in the molded part and which swings open in response to an overpressure in a space assigned to the closing screen, for example the interior of a vehicle, and which thus allows for an air escape from the space via the opening 4′.

The frame-shaped molded part 1′ is embodied so as to be substantially oval. In turn, it comprises a circumferential outer flange 12, which is embodied as a hollow bead. The opening 4′ provided with the ventilation flap 6′ is embodied in a ledge 11 of the molded part 1′, which stands back with respect to the outer flange 12 and which extends along the circumference together with the outer flange 12.

The ventilation flap 6′, which is embodied so as to be curved, is embodied in one piece with the molded part 1′. The linear connecting region of ventilation flap 6′ and molded part 1′ is embodied as a film hinge 9. The molded part 1′ comprises a collar 8 provided with an undercut 19. At its outer periphery, the collar 8 comprises several bulges, which are embodied in the region of the undercut 19. It can be seen that several pairs of the bulges are available, wherein two bulges 20 of a pair are in each case arranged so as to be located opposite to one another. The bulges 20 are embodied at the longitudinal sides as well as at the short longitudinal sides of the collar 8.

The bulges 20 are adapted to the edge circumference of an assigned ventilation opening 21, which is embodied, e.g., in an auto body sheet 22 or in a wall. The collar 8 is dimensioned in such a manner that the outer dimensions thereof are slightly smaller than the inner dimensions of the ventilation opening 21. However, the bulges 20 are embodied in such a manner that the outer dimensions thereof are slightly larger than the inner dimensions of the ventilation opening 21. In the assembled state of the closing screen, the bulges 20 cause a reduction of the opening 4′ provided with the ventilation flap 6′. In the assembled state of the closing screen, the edge of the ventilation flap 6′, which is defined by the cutout thereof from the molded part 1′, overlaps the opening 4′ approximately by the measure of one and two bulges 20, respectively. This leads to a good sealing of the opening 4′ by means of the ventilation flap 6′, which is embodied so as to be integral with the molded part 1′. In FIG. 5, hₖ defines the outer dimension and the height, respectively, which is defined by two bulges 20, which are located opposite and which are embodied on the transverse sides of the collar 8, while h_{L} in FIG. 6 defines the inner dimension and the height, respectively, of the ventilation opening 21.

The embodiment of the invention is not limited to the exemplary embodiments described above and illustrated in the drawing. Instead, a plurality of further alternatives is possible, which use the inventive concept specified in the enclosed claim, even in connection with a fundamentally different design. The at least one ventilation flap 6′ can thus also be connected to the molded part 1′ by means of a material connection by means of welding or adhesion, for example.

1. A closing screen for a ventilation opening, in particular for a ventilation opening for a motor vehicle, comprising at least one molded part (1; 1′) for fastening to the ventilation opening (2; 21) and at least one ventilation flap (6, 7; 6′), which closes an opening (4, 5; 4′) embodied in the molded part and which automatically allows for an air escape from an assigned space via the opening (4, 5; 4′) in response to an overpressure in the space, wherein the molded part (1; 1′) and the at least one ventilation flap (6, 7; 6′) are made of flexible, closed-cell foam and wherein the at least one ventilation flap (6, 7; 6′) is connected to the molded part (1; 1′) by means of a material connection or integrally.

2. The closing screen according to claim 1, wherein the molded part (1; 1′) is embodied in a frame-like manner and comprises a collar (8) provided with an undercut (19).

3. The closing screen according to claim 2, wherein the collar (8) comprises at its outer periphery several bulges (20) embodied in the region of the undercut (19).

4. The closing screen according to claim 3, wherein several pairs of the bulges (20) are available, wherein in each case two bulges (20) of a pair are arranged so as to be located opposite one another.

5. The closing screen according to claim 1, wherein the molded part (1; 1′) comprises a circumferential outer flange (12).

6. The closing screen according to claim 5, wherein the outer flange (12) is embodied as a hollow bead.

7. The closing screen according to claim 1, wherein the molded part (1; 1′) comprises a circumferential ledge (11), which defines the opening (4, 5; 4′).

8. The closing screen according to claim 1, wherein the at least one ventilation flap (6, 7; 6′) is connected to the molded part (1; 1′) via a film hinge (9)

9. The closing screen according to claim 1, wherein the at least one ventilation flap (6, 7; 6′) is embodied so as to be curved and comprises a collar (13, 14), which serves as a sealing surface.

10. The closing screen according to claim 1, further comprising a support (15) supporting the molded part (1), the rear side of which is provided with a pipe connection (16), wherein the pipe connection (16) is open towards the at least one ventilation flap (6, 7).

11. The closing screen according to claim 10, wherein the support (15), at its front side, comprises a collar (17), to which the molded part (1) can be fastened by means of a snap fit.
